(19) United States
(12) Patent Application Publication
(10) Pub. No.: US 2015/0247436 A1
(43) Pub. Date: Sep. 3, 2015

(54) ELECTRICALLY HEATED CATALYST APPARATUS AND METHOD FOR MANUFACTURING THE SAME

(71) Applicants: Masao Nakayama, Nagoya-shi (JP); Yasuo Kinoshita, Nagakute-shi (JP); Kenji Shimoda, Nagoya-shi (JP); Kazuaki Nishio, Nisshin-shi (JP)

(72) Inventors: Masao Nakayama, Nagoya-shi (JP); Yasuo Kinoshita, Nagakute-shi (JP); Kenji Shimoda, Nagoya-shi (JP); Kazuaki Nishio, Nisshin-shi (JP)

(73) Assignee: TOYOTA JIDOSHA KABUSHIKI KAISHA, Toyota-shi Aichi-ken (JP)

(21) Appl. No.: 14/429,563

(22) PCT Filed: Nov. 22, 2013
(86) PCT No.: PCT/IB2013/002602

§ 371 Date: Mar. 19, 2015

(30) Foreign Application Priority Data
Nov. 30, 2012 (JP) 2012-261952

(51) Int. Cl. F01N 3/20; H01R 43/02; F01N 3/28

(52) U.S. Cl. CPC F01N 3/2026; F01N 3/2825; H01R 43/02

(57) ABSTRACT

An electrically heated catalyst apparatus includes a carrier, a pair of surface electrodes, a wiring and a plurality of fixed layers. The carrier is formed of ceramics on which a catalyst is carried. The pair of surface electrodes face each other and are extended in an axial direction of the carrier on an outer peripheral surface of the carrier. The wiring is formed into a pectinate shape and is configured to supply electric power from an outside of the electrically heated catalyst apparatus to the surface electrode. The plurality of fixed layers is configured to fix the wiring on the surface electrode. The electrically heated catalyst apparatus is formed so that the carrier is electrically heated through the surface electrode. Elongation of the wiring is 15% or more.

### BACKGROUND OF THE INVENTION

1. Field of the Invention

The invention relates to an electrically heated catalyst apparatus and a method for manufacturing the same.

2. Description of Related Art

Recently, an electrically heated catalyst (EHC) has received a attention as an exhaust gas purifying device for purifying an exhaust gas discharged from an engine of an automobile and the like. In the EHC, even under condition when a temperature of an exhaust gas is low like immediately after an engine start and a catalyst has difficulty in activation, the catalyst can be forcibly activated by electrical heating, and a purifying efficiency of the exhaust gas can be improved.

According to the EHC disclosed in WO 2012/063353 A, on an outer peripheral surface of a cylindrical carrier having a honey-comb structure on which a catalyst such as platinum, palladium or the like is carried, a surface electrode that is extended in an axial direction of the carrier is formed. A pectinate wiring is connected to the surface electrode to supply an electric current. When the electric current spreads in a carrier axis direction in the surface electrode, an entire carrier is electrically heated. Thus, the catalyst carried by the carrier is activated, and unburned HC (hydrocarbon), CO (carbon monoxide), NOx (nitrogen oxide) and the like in the exhaust gas which goes through the carrier are purified by a catalytic reaction.

Since the EHC is disposed on an exhaust path in an automobile and the like, for materials of the surface electrode and wiring, a metal material that is excellent not only in the electric conductivity but also in heat resistance, oxidation resistance under high temperatures, corrosion resistance in an exhaust gas atmosphere and the like is used. On the other hand, as a material for the carrier, ceramic materials such as SiC (silicon carbide) and the like are used. Therefore, during electrical heating, thermal strain, due to a difference between a linear expansion coefficient of the metal material that forms the surface electrode and the wiring and a linear expansion coefficient of the ceramic material that forms the carrier, is generated. According to WO 2012/063353 A, in order to reduce the thermal strain, each of pectinately branched wirings is fixed to the surface electrode by a plurality of fixed layers disposed by distancing from each other.

On the other hand, since the wiring is a cold-rolled thin plate, that is, a processed material, the elongation is such small as about 1%. Therefore, the wiring may result in breakdown (thermal cycle fatigue breakdown) due to the thermal strain that is repeatedly loaded by thermal cycle.

### SUMMARY OF THE INVENTION

The invention was performed in view of the above situation and provides an electrically heated catalyst apparatus in which thermal cycle fatigue property of the wiring is improved.

An electrically heated catalyst apparatus according to an aspect of the invention includes: a carrier formed of ceramics on which a catalyst is carried; a pair of surface electrodes that face each other and are extended in an axial direction of the carrier on an outer peripheral surface of the carrier; a wiring is formed into a pectinate shape and is configured to supply electric power from an outside of the electrically heated catalyst apparatus to the surface electrode; and a plurality of fixed layers configured to fix the wiring to the surface electrode. The electrically heated catalyst apparatus is formed so that the carrier is electrically heated through the surface electrode. Elongation of the wiring is 15% or more. The wiring may be formed of an annealed material. According to such a structure, the thermal cycle fatigue property of the wiring can be improved.

Between the plurality of fixed layers, the wiring may have a bending part. In the structure like this, in particular, the thermal cycle fatigue property of the wiring can be improved. The wiring may have a throughhole at a position where the fixed layer is formed. According to the structure described above, a fixing force due to the fixed layer can be improved. Further, the wiring may be constituted by a first wiring and a second wiring. The first wiring is formed into a pectinate shape, extended in a circumferential direction of the carrier, and connected to a center portion of the surface electrode in the axial direction. The second wiring is formed into a pectinate shape and extended in the axial direction from the first wiring toward an end of the surface electrode in the axial direction.

A method for manufacturing an electrically heated catalyst apparatus according to a second aspect of the invention includes: forming a pair of the surface electrodes that face each other and are extended in an axial direction of a carrier on an outer peripheral surface of the carrier formed of ceramic on which a catalyst is carried; and fixing a wiring on the surface electrode by a plurality of fixed layers, the wiring being configured to supply electric power from an outside of the electrically heated catalyst apparatus, being formed into a pectinate shape and having elongation of 15% or more. The electrically heated catalyst apparatus is formed so that the carrier is electrically heated through the surface electrode. The method for manufacturing according to the second aspect of the invention may include forming the wiring of an annealed material. According to such a structure, the thermal cycle fatigue property of the wiring can be improved.

The method for manufacturing according to the second aspect of the invention may include annealing the wiring by subjecting the wiring to heat treatment. Furthermore, the wiring may be annealed by electrically heating the electrically heated catalyst device after fixing the wiring made of a processed material on the surface electrode. Thus, the productivity can be improved. The method for manufacturing according to the second aspect of the invention may include forming a bending part between positions where the plurality of fixed layers is formed in the wiring. According to such a structure, in particular, the thermal cycle fatigue property of the wiring can be improved. The method for manufacturing according to the second aspect of the invention may include forming a throughhole at a position where the plurality of fixed layers is formed in the wiring. A fixing force due to the fixed layer can be improved. The method for manufacturing according to the second aspect of the invention may include constituting the wiring by a first wiring and a second wiring. The first wiring is formed into a pectinate shape, extended in a circumferential direction of the carrier, and connected to a center part of the surface electrode in the axial direction. The second wiring is formed into a pectinate shape and extended in the axial direction from the first wiring toward an end of the surface electrode.

According to the first and second aspects of the invention, an electrically heated catalyst apparatus of which thermal cycle fatigue property of the wiring was improved can be provided.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a perspective view of an electrically heated catalyst apparatus 100 according to Embodiment 1;

FIG. 2 is a plan view when the electrically heated catalyst apparatus 100 according to the Embodiment 1 is seen from directly above a surface electrode 31;

FIG. 3 is a horizontal section taken along a section line in FIG. 2;

FIG. 4 is a plan view when the electrically heated catalyst apparatus 100 according to a modification example of the Embodiment 1 is seen from directly above the surface electrode 31;

FIG. 5 is a cross section taken along a V-V section line in FIG. 2 and a vertical section of a second wiring 32b at a site where a bending part 34 is formed;

FIG. 6A is an image diagram that shows by comparing stress-strain curves of a processed material and an annealed material;

FIG. 6B is an image diagram that shows by comparing s-N curves of the processed material and the annealed material;

FIG. 7A is a plan view of a wiring 32 of an electrically heated catalyst apparatus according to Embodiment 2;

FIG. 7B is a cross-section taken along a VIIB-VIIB section line of FIG. 7A;

FIG. 7C is a cross-section taken along a VIIC-VIIC section line of FIG. 7A;

FIG. 8 is a modification example of a horizontal section taken along a III-III section line in FIG. 2; and

FIG. 9 is a horizontal section in the Embodiment 2 corresponding to FIG. 8.

### DETAILED DESCRIPTION OF EMBODIMENTS

Hereinafter, specific embodiments to which the invention was applied will be described in detail with reference to the drawings. However, the invention is not restricted to embodiments described below. Further, for the purpose of clarification of the description, description and the drawings below are appropriately simplified.

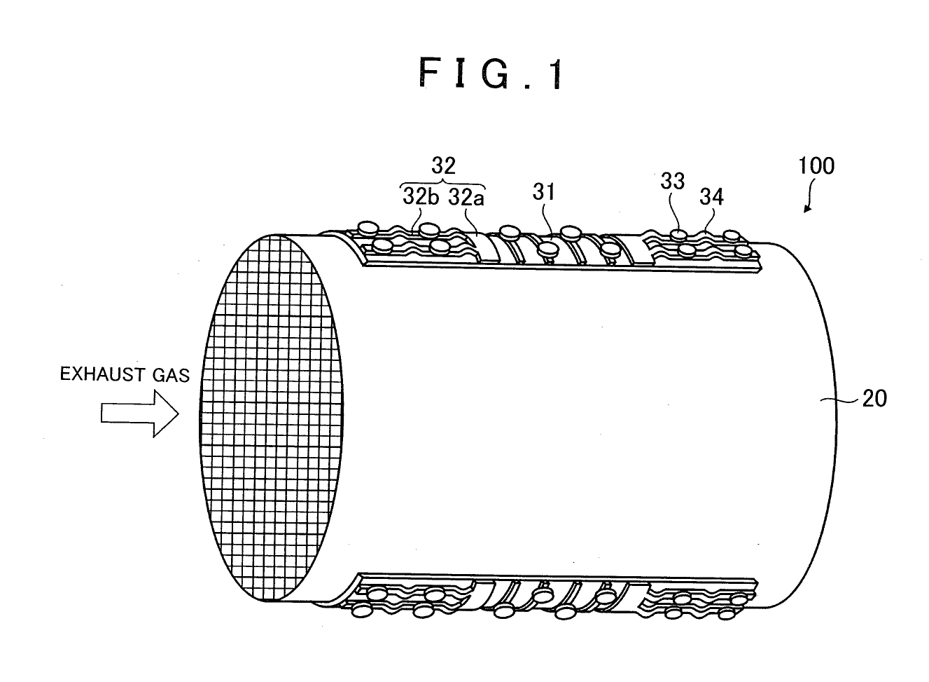

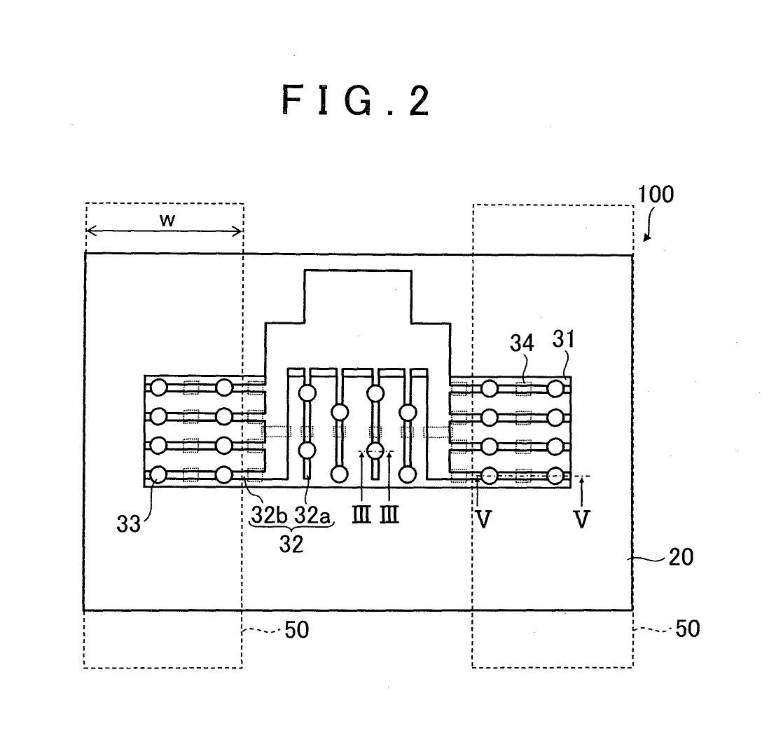

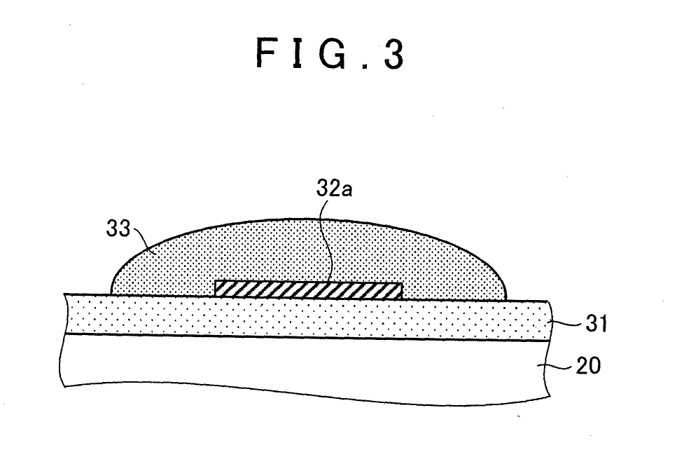

First, with reference to FIG. 1 to FIG. 3, an electrically heated catalyst apparatus according to embodiment 1 will be described. FIG. 1 is a perspective view that shows an electrically heated catalyst apparatus 100 according to embodiment 1. FIG. 2 is a plan view when the electrically heated catalyst apparatus 100 according to the embodiment 1 is seen from directly above a surface electrode 31. FIG. 3 is a cross section taken along a III-III section line in FIG. 2, and a cross section at a site where a fixed layer 33 is formed.

The electrically heated catalyst apparatus 100 is disposed on a discharge path of an automobile and the like, for example, and purifies an exhaust gas discharged from an engine. As shown in FIG. 1, the electrically heated catalyst apparatus 100 includes a carrier 20, a surface electrode 31, a wiring 32, and a fixed, layer 33. Herein, the wiring 32 includes a first wiring 32a extended in a carrier circumferential direction and a second wiring 32b extended in a carrier axis direction. In FIG. 2, although a positional relationship of the carrier 20, the wiring 32, and the fixed layer 33 is shown for one surface electrode 31, the situation is the same also for the other surface electrode 31.

The carrier 20 is a porous member that carries a catalyst such as platinum, palladium and the like. Further, since the carrier 20 itself is electrically heated, it is formed of ceramics having conductivity, specifically SiC (silicon carbide), for example. As shown in FIG. 1, the carrier 20 has a substantially, cylindrical outer shape and a honeycomb structure inside thereof. As shown with an arrow mark, an exhaust gas passes the inside of the carrier 20 in an axial direction of the carrier 20.

As shown in FIG. 1, the surface electrode 31 is a pair of electrodes that are disposed while facing each other on an external surface of the carrier 20. Further, as shown in FIG. 2, the surface electrode 31 has a rectangular plane shape and is extended in a carrier axis direction. The surface electrode 31 is not formed in the vicinity of both ends of the carrier 20 in a carrier axis direction. The surface electrode 31 is connected to a power source such as a battery or the like through the wiring 32. Then, through the surface electrode 31, an electric current is supplied to the carrier 20 to perform electrical heating. One of the pair of surface electrodes 31 is a plus electrode and the other is a minus electrode. However, any of the surface electrodes 31 may be a plus electrode or a minus electrode. That is, a direction of the electric current that flows the carrier 20 is not limited.

As shown in FIG. 1, a pectinately branched wiring 32 is disposed on each of the pair of surface electrodes 31. The wiring 32 has a plurality of first wirings 32a extended pectinately in a circumferential direction of the carrier 20 and a plurality of second wirings 32b extended pectinately in a carrier axis direction. Both the first wiring 32a and the second wiring 32b come into physical contact with the surface electrode 31 and are electrically connected therewith. The first wiring 32a and the second wiring 32b are a ribbon-shaped metal thin plate having a thickness of 0.1 mm and a width of about 1 mm, for example. Further, in order to be able to use under high temperatures of 800° C. or more, the wiring 32 is preferably made of a heat resistant (anti-oxidation) alloy such as stainless alloy, Ni-based alloy, Co-based alloy and the like. When considering performances such as electric conductivity, heat resistance, oxidation resistance under high temperatures, corrosion resistance under an exhaust gas atmosphere and the like and cost, the stainless alloy is the most preferable.

As shown in FIG. 2, the plurality of first wirings 32a is extended over an entire formation region of the surface electrode 31 in a carrier circumferential direction. Further, all of the first wirings 32a are extended while protruding from one side of the formation region of the surface electrode 31, and integrated at the protruded dead end. On the other hand, the plurality of the first wirings 32a is juxtaposed, along a carrier axis direction, separated by a substantially equal distance on the surface electrode 31. The first wiring 32a is disposed only on a center part in a carrier axis direction of the surface electrode 31. In an example of FIGS. 1 and 2, six first wirings 32a are disposed in a center part in an axial direction of the carrier 20 on each of the surface electrodes 31. Herein, two first wirings 32a disposed on the outermost side are formed thicker compared with the other four first wirings 32a. It goes without saying that the number of the first wirings 32a is not limited to six but can be appropriately determined.

The second wiring 32b is continuously extended from two first wirings 32a located on the outermost side up to an edge of the surface electrode 31 in a carrier axis direction. In an example of FIGS. 1 and 2, from each of two first wirings 32a located on the outermost side, four second wirings 32b are extended.

In the electrically heated catalyst apparatus 100 according to the embodiment, from the first wiring 32a disposed only in a center part in a carrier axis direction of the surface electrode 31, the second wiring 32b is extended toward an end in a carrier axis direction of the surface electrode 31. Therefore, even when the surface electrode 31 is cracked in a carrier circumferential direction due to deterioration, spreading of the electric current in a carrier axis direction can be maintained due to the second wiring 32b. Therefore, the vicinity of the center part in an axis direction of the carrier 20 is not intensively heated, and the thermal stress crack due to the intensive heating can be avoided.

As shown in FIGS. 1 and 2, each of four of the first wirings 32a that are disposed inside and all of the second wirings 32b is fixed to the surface electrode 31 by the plurality of fixed layers 33 that are disposed apart from each other. In other words, between the adjacent fixed layers 33, the first wiring 32a and the second wiring 32b are not fixed to the surface electrode 31. According to such a structure, thermal strain (thermal stress) based on the difference between the linear expansion coefficient of the surface electrode 31 and the fixed layer 33, which are a thermal sprayed coating based on metal, and the linear expansion coefficient of the carrier 20 made of ceramics can be reduced. That is, by forming the individual fixed layers 33 in a shape as small as possible so as to be sprinkled, the thermal strain (thermal stress) is reduced.

Further, according to an example of FIGS. 1 and 2, one fixed layer 33 is disposed in the vicinity of both ends of each of the first wiring 32a and the second wiring 32b. Further, as shown in FIG. 2, between the adjacent first wirings 32a, the fixed layers 33 are disposed so as to be displaced each other in a carrier circumferential direction. In other words, on each of the surface electrodes 31, four fixed layers 33 are disposed on one side in a zigzag manner in a carrier axis direction along two longer sides of a rectangular surface electrode 31. On the other hand, between adjacent second wirings 32b, the fixed layers 33 are disposed at the same place in a carrier axis direction. Incidentally, arrangement intervals of the fixed layers 33 can appropriately be determined.

Herein, FIG. 3 is a cross section taken along a section line in FIG. 2 and a horizontal section at a site where the fixed layer 33 is formed. As shown in FIG. 3, the surface electrode 31 is a sprayed coating that is formed on an outer peripheral surface of the carrier 20 by plasma spraying, for example, and has a thickness of 50 to 200 μm. The surface electrode 31 is in physical contact with the carrier 20 and electrically connected therewith.

The fixed layer 33 is a button-shaped sprayed coating that is formed so as to cover the first wiring 32a and has a thickness of about 300 to 500 μm. The fixed layer 33 can be formed in such a manner that the first wiring 32a, is disposed on the surface electrode 31, thereon a masking jig is disposed, and the plasma spraying is carried out. As shown in FIG. 3, the fixed layer 33 comes into physical contact with the first wiring 32a and the surface electrode 31 and is electrically connected therewith. The situation is the same for the fixed layer 33 formed on the second wiring 32b.

Further, each of the first wirings 32a is provided with a bending part 34 in a center part in a carrier circumferential direction. That is, each of the four first wirings 32a located inside is provided with the bending part 34 between two fixed layers 33. On the other hand, each of the second wirings 32b is provided with two bending parts 34. Specifically, one bending part 34 is disposed between two fixed layers 33 in each of the second wirings 32b. The other bending part 34 is disposed at a connection part of each of the second wirings 32b with the first wiring 32a (between the first wiring 32a and one fixed layer 33). According to such a structure, thermal strain (thermal stress) based on the difference of, linear expansion coefficients between the wiring 32 made of metal and the carrier 20 made of ceramics can be reduced.

The sprayed coating that forms the surface electrode 31 and the fixed layer 33 is necessary to be a metal based material for energizing in the same manner as the wiring 32. A metal that forms a matrix of the sprayed coating is necessary to endure high temperatures of 800° C. or more. Therefore, Ni—Cr alloys (Cr content: 20 to 60% by mass) and MCrAlY alloys (M is at least one kind of Fe, Co and Ni), which have excellent oxidation resistance under high temperatures are preferable. Herein, the NiCr alloys and MCrAlY alloys may contain other alloying elements. The sprayed coating that forms the surface electrode 31 and the fixed layer 33 may be porous. When the sprayed coating is porous, a function of reducing the stress can be improved.

The carrier 20 is fixed and held on a discharge path by a mat 50 made of a heat resistant material in the vicinity of both ends in the carrier axis direction. Further, the mat 50 has a function of protecting the carrier 20, sealing an exhaust gas, and not allowing it to leak outside. In order to secure the sealability, the mat 50 preferably has a width w of 30 mm or more.

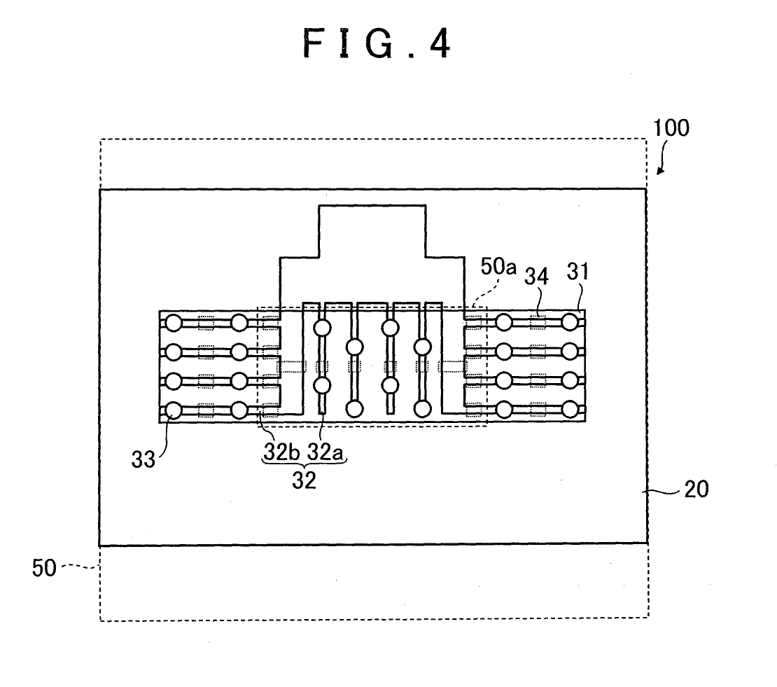

FIG. 4 is a plan view when the electrically heated catalyst apparatus 100 according to a modification example of embodiment 1 is seen from directly above the surface electrode 31. In FIG. 4, the mat 50 is disposed over a substantial entirety of the carrier 20. On the other hand, in a center part in the carrier axis direction in the mat 50, an opening 50a for pulling out the wiring 32 from the carrier 20 is disposed. Herein, from the viewpoint of reducing the temperature difference in the carrier 20, the opening 50a is preferably as small as possible. Other structure is the same as FIG. 2.

According to the above structure, in the electrically heated catalyst apparatus 100, the carrier 20 is electrically heated between a pair of surface electrodes 31, and a catalyst carried on the carrier 20 is activated. Thus, unburned HC (hydrocarbon), CO (carbon monoxide), NOx (nitrogen oxide) and the like in the exhaust gas, which go through the carrier 20 are purified according to a catalytic reaction.

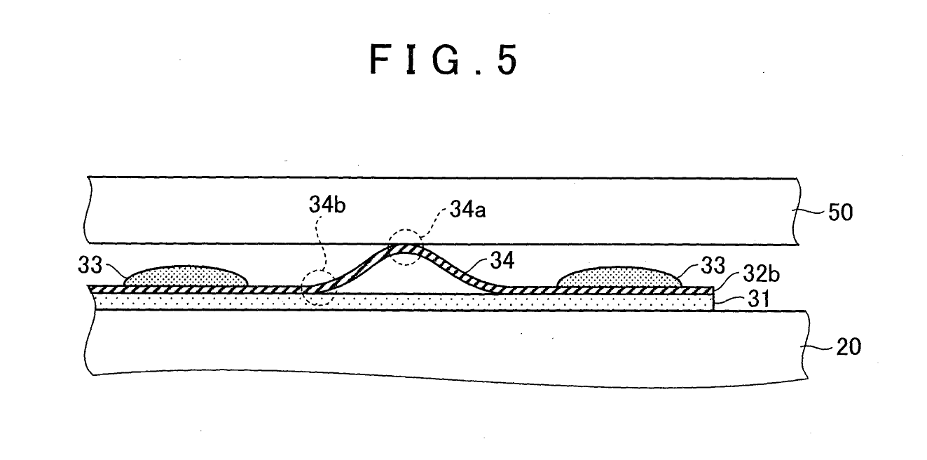

Herein, FIG. 5 is a cross section taken along a V-V section line in FIG. 2, and a vertical section of the second wiring 32b in a site where the bending part 34 is formed. As shown in FIG. 5, the bending part 34 is disposed between two fixed layers 33 formed on the second wiring 32b. Herein, a height of the bending part 34 from the surface electrode 31 is higher than a height (thickness) of the fixed layer 33. Therefore, a tip 34a of the bending part 34 is pushed by the mat 50 and restrained. Further, since the tip 34a is pushed by the mat 50, a root part 34b of the bending part 34 is pushed to the surface electrode 31 and restrained.

Incidentally, as shown in FIGS. 2 and 4, on the bending part 34 formed on the first wiring 32a, the mat 50 is not disposed in many cases. However, as described above, the opening 50a in FIG. 4 is preferably formed as small as possible. Accordingly, in the case where the mat 50 is disposed also on the bending part 34 formed on the first wiring 32a, restraint due to the mat 50 is similarly generated.

In the related art, as the wiring 32, a cold-rolled thin plate, that is, a processed material (elongation: about 1%) has been used. Therefore, in the tip 34a and the root part 34b of the restrained bending part 34, it was likely that the wiring 32 is broken due to thermal cycle load. On the other hand, in the electrically heated catalyst apparatus 100 according to the embodiment, since, as the wiring 32, an annealed material (elongation: 15 to 25%) obtained by annealing a cold rolled thin plate is used, the wiring 32 can be prevented from breaking due to thermal cycle load. That is, the number of thermal cycles during which the wiring 32 reaches breakdown can be increased, and, the wiring 32 can have a longer life thereby. That is, the thermal cycle fatigue property of the wiring 32 can be improved. Herein, the elongation of the wiring 32 is preferably at least 15% or more. There is no particular upper limit in the elongation.

Incidentally, after the electrically heated catalyst apparatus 100 was manufactured using the wiring 32 made of a processed material, an annealed material may be formed by electrically heating the wiring 32 in an energization inspection step. That is, by making use of electrical heating of the electrically heated catalyst apparatus 100, the wiring 32 is subjected to heat treatment, and an annealed material may be formed thereby. Therefore, an annealing treatment step of the wiring 32 can be omitted, and the productivity can be improved thereby.

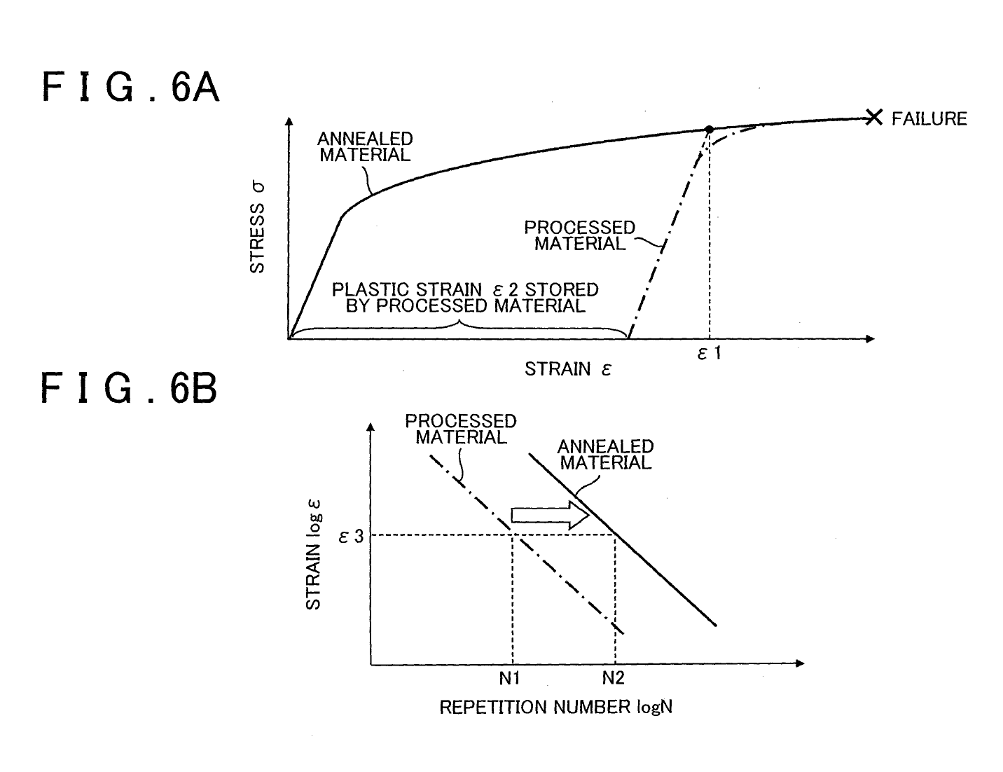

Herein, with reference to FIG. 6A and FIG. 6B, a mechanism according to which such an effect is assumed will be described. FIG. 6A is an image diagram that shows by comparing stress-strain curves of a processed material and an annealed material. FIG. 6B is an image diagram that shows by comparing E-N curves of a processed material and an annealed material. Breakdown due to the thermal cycle load of the wiring 32 made of a conventional processed material is considered a low cycle fatigue failure due to accumulation of the plastic strain.

As shown in a stress-strain curve of FIG. 6A, the processed material corresponds to an annealed material obtained by, after loading strain ε1 to an annealed material, releasing it. Therefore, as shown in FIG. 6A, in the processed material, the plastic strain is stored by plastic strain ε2 more than the annealed material. In other words, the annealed material can store the plastic strain by ε2 more than the processed material until failure is reached. Therefore, as shown in an ε-N curve of FIG. 6B, it is considered that the repetition number (N) up to the failure when a constant strain ε3 is continually loaded can be increased. In FIG. 6B, the repetition number N1 for the processed material is increased to the repetition number N2 for the annealed material. The thermal strain due to the thermal cycle load is due to a difference of the linear expansion coefficients between the metal material that forms the wiring 32 and the ceramic material that forms the carrier 20. Therefore, the thermal strain due to the thermal cycle load can be considered the same when the thermal cycle condition is the same.

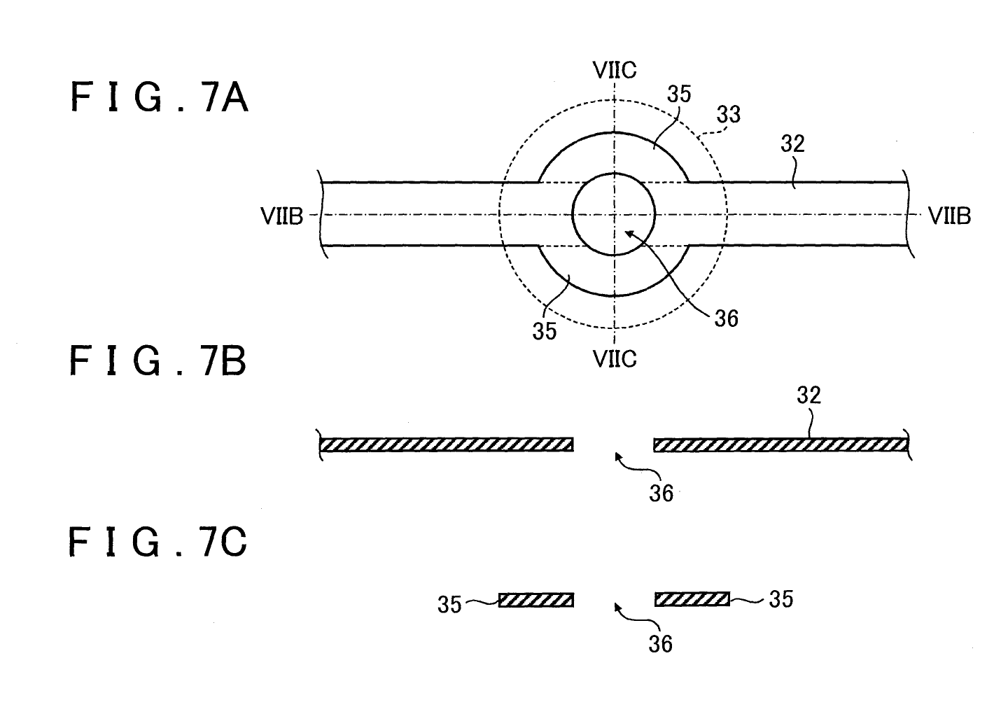

Next, with reference to FIGS. 7A. to 7C, an electrically heated catalyst apparatus according to embodiment 2 will be described. FIG. 7A is a plan view of the wiring 32 of the electrically heated catalyst apparatus according to embodiment 2. FIG. 7B is a cross section taken along a section line VIIB-VIIB of FIG. 7A. FIG. 7C is a cross section taken along a section line VIIC-VIIC of FIG. 7A. As shown in FIGS. 7A to 7C, in the wiring 32 (the first wiring 32a and the second wiring 32b) according to the embodiment 2, at a position where a circular fixed layer 33 is formed, a throughhole 36 that is concentric with the fixed layer 33 is formed. In the surrounding of the throughhole 36, two bypass wirings 35 are formed.

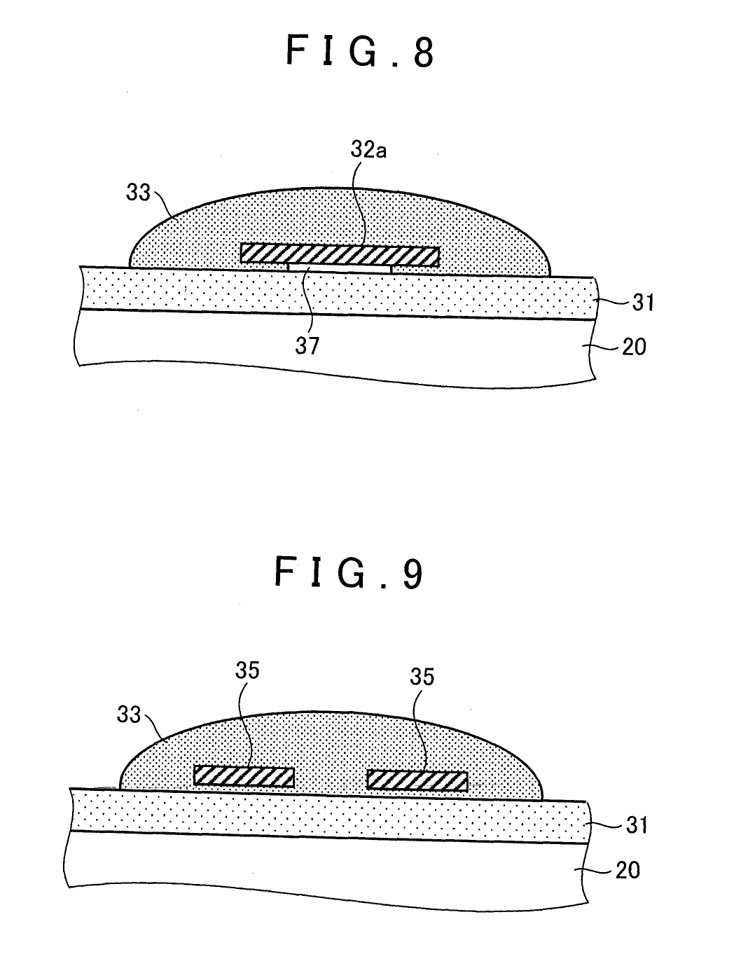

FIG. 8 is a modification example of a horizontal section taken along a III-III section line in FIG. 2. When compared with FIG. 3, in FIG. 8, the surface electrode 31 and the first wiring 32a are not closely attached, and a void 37 is formed therebetween. When the fixed layer 33 is formed by thermal spraying, as shown in FIG. 8, the void 37 may be formed between the surface electrode 31 and the first wiring 32a. According to the void 37 like this, it is likely that a fixing force due to the fixed layer 33 is decreased, an energization area is decreased, and power supply to the carrier 20 becomes unstable.

On the other hand, FIG. 9 is a horizontal section in embodiment 2 corresponding to FIG. 8. As shown in FIG. 9, when the wiring 32 according to embodiment 2 is used, the fixed layer 33 can come into contact with the surface electrode 31 through the throughhole 36. Further, since the fixed layer 33 can intrude under the bypath wiring 35 of the wiring 32, the void is not formed. Therefore, in comparison with a case like FIG. 8 according to embodiment 1, the fixing force due to the fixed layer 33 is improved, an energization area is increased, and power supply to the carrier 20 can be stabilized. Herein, a total of cross-section areas of two bypath wirings 35 in FIG. 9 is preferably set to a cross-section area of the wiring 32 in FIG. 8 or more.

Although, hereinafter, specific examples according to embodiment 1 will be described, the invention is not restricted to these examples. In Example 1, a cold-rolled material of stainless-based alloy (Fe-20% by mass of Cr-5% by mass of Al) having a thickness of 0.1 mm was cooled in a furnace after heat treatment at 900° C. for 5 minutes under an inert gas atmosphere, and the wiring 32 made of an annealed material was prepared thereby. The wiring 32 made of the annealed material had linear expansion coefficient=11.5×10⁻⁶/° C., elongation=20%, tensile strength=715 N/mm², and bickers hardness=236 Hv.

Next, on a surface of the carrier 20 made of SiC, by plasma spraying, the surface electrode 31 having a thickness of 0.15 mm was formed. Herein, a linear expansion coefficient of SiC is 4.6×10⁻⁶/° C. Next, on the surface electrode 31, the wiring 32 made of the annealed material was disposed, thereon, by plasma spraying using a masking jig, the fixed layer 33 having a thickness of 0.4 mm was formed. As shown in FIG. 2, sixteen fixed layers 33 were formed on each of the two surface electrodes 31, that is, thirty two fixed layers 33 were formed in total.

A composition of the sprayed coating (surface electrode 31 and fixed layer 33) was Ni-50% by mass of Cr-32.5% by mass of bentonite, that is, a composite material made of a metal phase and a bentonite phase. After loading thermal cycle (150 to 900° C., 10 minutes×1000 cycles) to the prepared electrically heated catalyst apparatus, whether the wiring 32 was disconnected or not was confirmed. None of disconnection of the wiring 32 was found.

According to comparative example 1, the wiring 32 made of a cold-rolled material of stainless-based alloy (Fe-20% by mass of Cr-5% by mass of Al) having a thickness of 0.1 mm was prepared. The wiring 32 made of the processed material had linear expansion coefficient=11.5×10⁻⁶/° C., elongation=1%, tensile strength=1330 N/mm², and bickers hardness=390 Hv. Other conditions than the above were the same as example 1. Twenty one disconnections of the wiring 32 were found. All of the disconnections were found at the bending parts 34 shown in FIG. 2. Herein, as shown in FIG. 2, the electrically heated catalyst apparatus has sixteen bending parts 34 for each of two surface electrodes 31, that is, thirty two bending parts 34 in total. That is, among thirty two bending parts 34, twenty one bending parts 34 were found disconnected.

From results of example 1 and comparative example 1, it was found that when the wiring 32 was changed from the processed material to the annealed material, the disconnection due to the thermal cycle load can be effectively prevented.

The invention is not restricted to the embodiments described above and can be appropriately modified in the range that does not deviate from gist.

1. An electrically heated catalyst apparatus comprising:
a carrier formed of ceramics on which a catalyst is carried;
a pair of surface electrodes that face each other and are extended in an axial direction of the carrier on an outer peripheral surface of the carrier;
a wiring that is formed into a pectinate shape and is configured to supply electric power from an outside of the electrically heated catalyst apparatus to the surface electrode; and
a plurality of fixed layers configured to fix the wiring to the surface electrode, wherein
the carrier is electrically heated through the surface electrode, and
the wiring is formed of an annealed material.

2. (canceled)

3. The electrically heated catalyst apparatus according to claim 1, wherein the wiring is provided with a bending part between the fixed layers.

4. The electrically heated catalyst apparatus according to claim 1, wherein the wiring has a throughhole at a position where the fixed layer is formed.

5. The electrically heated catalyst apparatus according to claim 1, wherein
the wiring is constituted by a first wiring and a second wiring,
the first wiring is formed into a pectinate shape, extended in a circumferential direction of the carrier, and connected to a center portion of the surface electrode in the axial direction, and
the second wiring is formed into a pectinate shape and extended in the axial direction from the first wiring toward an end of the surface electrode in the axial direction.

6. A method for manufacturing an electrically heated catalyst apparatus comprising:
forming a pair of surface electrodes that face each other and are extended in an axial direction of a carrier on an outer peripheral surface of the carrier formed by ceramics on which a catalyst is carried; and
fixing a wiring on the surface electrode by a plurality of fixed layers, the wiring being configured to supply electric power from an outside of the electrically heated catalyst apparatus, being formed into a pectinate shape and having elongation of 15% or more,
wherein the carrier is electrically heated through the surface electrode.

7. (canceled)

8. The method for manufacturing according to claim 6, further comprising:
annealing the wiring by subjecting the wiring to heat treating.

9. The method for manufacturing according to claim 8, wherein the wiring is annealed by electrically heating the electrically heated catalyst apparatus after fixing the wiring made of a processed material on the surface electrode.

10. The method for manufacturing according to claim 6, further comprising:
forming a bending part between positions where the fixed layers are formed in the wiring.

11. The method for manufacturing according to claim 6, further comprising:
forming a throughhole at a position where the fixed layers fixed layer is formed in the wiring.

12. The method for manufacturing according to claim 6, further comprising:
constituting the wiring by a first wiring and a second wiring, wherein
the first wiring is formed into a pectinate shape, extended in a circumferential direction of the carrier and connected to a center part of the surface electrode in the axial direction, and
the second wiring is formed into a pectinate shape and extended in the axial direction from the first wiring toward an end of the surface electrode in the axial direction.
